(19) United States
(12) Patent Application Publication
(10) Pub. No.: US 2018/0137408 A1
(43) Pub. Date: May 17, 2018

(54) METHOD AND SYSTEM FOR EVENT-BASED NEURAL NETWORKS

(71) Applicant: SOCOPRA SCIENCES ET GENIE S.E.C., Sherbrooke (CA)

(72) Inventors: Frederic MAILHOT, Sherbrooke (CA); Guillaume SEGUIN-GODIN, Sherbrooke (CA); Jean ROUAT, Quebec (CA)

(21) Appl. No.: 15/576,673

(22) PCT Filed: May 20, 2016
(86) PCT No.: PCT/CA2016/050579

§ 371 Date: Nov. 22, 2017

Related U.S. Application Data
(60) Provisional application No. 62/165,467, filed on May 22, 2015.

(51) Int. Cl. G06N 3/04; G06N 3/08; G06N 3/10

(52) U.S. Cl. CPC G06N 3/049; G06N 3/10; G06N 3/08

(57) ABSTRACT

The present disclosure describes systems and methods for operating an event-driven spiking neural network. The neural network is based on a pipelined comparator tree used to find the next neuron to fire (as per the event-driven simulation strategy), with each neuron having a firing time associated therewith. The neuron's discharge is then processed by updating the post-synaptic neurons affected by the firing event. The architecture can be duplicated or otherwise scaled to increase the performance of the system.

### CROSS-REFERENCE TO RELATED APPLICATIONS

This application claims priority under 35 U.S.C. 119(e) of U.S. Provisional Application No. 62/165,467, filed on May 22, 2015, entitled “Hardware Architecture for Spiking Neural Networks”, which is hereby incorporated by reference in its entirety.

### TECHNICAL FIELD

The present invention relates generally to neural networks, and more specifically to methods and systems for event-based artificial spiking neural networks.

### BACKGROUND OF THE ART

Artificial spiking neural networks (SNNs) have earned interest in the past decades and are now widely used in multiple artificial intelligence tasks, such as image recognition and sound source separation. This is due to the fact that these neural networks are not only more biologically realistic than neural networks using previous generations of neurons but they were also proven to be more computationally powerful. Artificial spiking neural networks have been implemented on many hardware devices like graphical processing units (GPUs), field-programmable gate arrays (FPGAs) and application-specific integrated circuits (ASICs).

When simulating spiking neural networks, one can consider a time-driven or an event-driven strategy. While the event-driven strategy is widely used in software implementations because of its efficiency, most published works on hardware artificial spiking neural networks use a time-driven approach. This might be explained by the difficulty of implementing an event-driven algorithm which supports biologically accurate models. However, hardware implementations using a simple neuron model, such as the leaky integrate-and-fire (LIF) model, could benefit from the event-driven strategy, pairing the efficiency of the event-driven approach with the parallel computational capability of hardware implementations.

### SUMMARY

The present disclosure describes systems and methods for operating an event-driven spiking neural network. The neural network is based on a pipelined comparator tree used to find the next neuron to fire (as per the event-driven simulation strategy), with each neuron having a firing time associated therewith. The neuron's discharge is then processed by updating the post-synaptic neurons affected by the firing event. The architecture can be duplicated or otherwise scaled to increase the performance of the system.

In accordance with a first broad aspect, there is provided a method for operating an event-driven neural network comprising a plurality of neurons. The method comprises: (i) setting an initial state of the network and (ii) determining a next event in the network as a time to a next neuron firing. Step (ii) comprises: (a) populating entries of a top level of at least one multi-level comparator with values representative of neuron firing times; (b) comparing pairs of entries and selecting from each pair an entry having a closest neuron firing time; (c) propagating the selected ones from each pair to a next level of the comparator and updating the entries of the top level with one or more new values; (d) repeating steps (b) and (c) until all top level entries are updated and no new values are written to any level of the comparator; and (e) determining the time to a next neuron firing based on the neuron firing time of the value in the final level. The method further comprises (iii) setting a subsequent time of simulation to the next neuron firing time and (iv) simulating the network at the subsequent time of simulation.

In some embodiments, steps (b) and (c) are performed over one clock cycle. In some embodiments, the method further comprises repeating steps (ii) to (iv) iteratively during operation of the network.

In some embodiments, selecting from each pair an entry comprises promoting a random one of the entries of a pair when the associated neuron firing times are identical.

In some embodiments, the method further comprises distributing the plurality of neurons across a plurality of processing elements each having a comparator, performing steps (a) to (d) in parallel in each one of the processing elements, and outputting intermediate values from the final level of each comparator of each processing element; inputting the intermediate values into a merger unit having a comparator; and performing steps (a) to (d) in the merger unit with the intermediate values set as top level entries.

In some embodiments, the method further comprises storing data associated with every neuron that is about to fire in pre-synaptic neuron memories provided in each one of the processing elements.

In some embodiments, the method further comprises identifying as synchronized neurons any neurons from separate processing elements that are set to fire at a same time; and redirecting the synchronized neurons to a same processing element. In some embodiments, the synchronized neurons are pairs of pre-synaptic and post-synaptic neurons.

In some embodiments, simulating the network at the subsequent time of simulation comprises: finding post-synaptic neurons associated with pre-synaptic neurons ready to fire; determining synaptic weights between the post-synaptic neurons and the pre-synaptic neurons ready to fire; determining potential values of the post-synaptic neurons upon fire; and updating next firing times and values for the pre-synaptic neurons and the post-synaptic neurons.

In accordance with another broad aspect, there is provided a spiking neural network comprising a memory having stored thereon program code executable by a processor and at least one processing unit. The processing unit is configured for (i) setting an initial state of the network and (ii) determining a next event in the network as a time to a next neuron firing. Step (ii) comprises: (a) populating entries of a top level of at least one multi-level comparator with values representative of neuron firing times; (b) comparing pairs of entries and selecting from each pair an entry having a closest neuron firing time; (c) propagating the selected ones from each pair to a next level of the comparator and updating the entries of the top level with one or more new values; (d) repeating steps (b) and (c) until all top level entries are updated and no new values are written to any level of the comparator; and (e) determining the time to a next neuron firing based on the neuron firing time of the value in the final level. The processing unit is also configured for (iii) setting a subsequent time of simulation to the next neuron firing time and (iv) simulating the network at the subsequent time of simulation.

In some embodiments, steps (b) and (c) are performed over one clock cycle. In some embodiments, the method further comprises repeating steps (ii) to (iv) iteratively during operation of the network.

In some embodiments, selecting from each pair an entry comprises promoting a random one of the entries of a pair when the associated neuron firing times are identical.

In some embodiments, the processing unit is further configured for distributing the plurality of neurons across a plurality of processing elements each having a comparator, performing steps (a) to (d) in parallel in each one of the processing elements, and outputting intermediate values from the final level of each comparator of each processing element; inputting the intermediate values into a merger unit having a comparator; and performing steps (a) to (d) in the merger unit with the intermediate values set as top level entries.

In some embodiments, the processing unit is further configured for storing data associated with every neuron that is about to fire in pre-synaptic neuron memories provided in each one of the processing elements.

In some embodiments, the processing unit is further configured for identifying as synchronized neurons any neurons from separate processing elements that are set to fire at a same time; and redirecting the synchronized neurons to a same processing element. In some embodiments, the synchronized neurons are pairs of pre-synaptic and post-synaptic neurons.

In some embodiments, simulating the network at the subsequent time of simulation comprises: finding post-synaptic neurons associated with pre-synaptic neurons ready to fire; determining synaptic weights between the post-synaptic neurons and the pre-synaptic neurons ready to fire; determining potential values of the post-synaptic neurons upon fire; and updating next firing times and values for the pre-synaptic neurons and the post-synaptic neurons.

In accordance with yet another aspect, there is provided a non-transitory computer-readable medium having stored thereon instructions for operating an event-based neural network. The instructions are executable by a processing unit for (i) setting an initial state of the network and (ii) determining a next event in the network as a time to a next neuron firing. Step (ii) comprises: (a) populating entries of a top level of at least one multi-level comparator with values representative of neuron firing times; (b) comparing pairs of entries and selecting from each pair an entry having a closest neuron firing time; (c) propagating the selected ones from each pair to a next level of the comparator and updating the entries of the top level with one or more new values; (d) repeating steps (b) and (c) until all top level entries are updated and no new values are written to any level of the comparator; and (e) determining the time to a next neuron firing based on the neuron firing time of the value in the final level. The instructions are also executable for (iii) setting a subsequent time of simulation to the next neuron firing time, (iv) simulating the network at the subsequent time of simulation, and (v) repeating steps (ii) to (iv) iteratively during operation of the network.

### BRIEF DESCRIPTION OF THE DRAWINGS

Further features and advantages of the present invention will become apparent from the following detailed description, taken in combination with the appended drawings, in which:

FIG. 1 is a flowchart of a method for operating an event-driven neural network in accordance with an embodiment.

FIG. 2 is a flowchart of a method for determining a next event in the network in accordance with an embodiment.

FIG. 3 is a schematic diagram of an example architecture of an eight-neuron pipelined comparator tree, in accordance with an embodiment.

FIGS. 4A, 4B, 4C, 4D are schematic diagrams of an example operation of the pipelined comparator tree of FIG. 3, in accordance with an embodiment.

FIG. 5 is a schematic diagram of an example architecture for an event-driven hardware spiking neural network, in accordance with an embodiment.

FIG. 6 is a schematic diagram of an example synaptic processing element.

FIGS. 7A and 7B are schematic diagrams of example systems for implementing the methods of FIGS. 1 and 2 in accordance with an embodiment.

FIGS. 8A and 8B illustrate an original image (a) and a segmented image (b), obtained using the methods of FIGS. 1 and 2.

It will be noted that throughout the appended drawings, like features are identified by like reference numerals.

### DETAILED DESCRIPTION

An artificial event-driven spiking neural network (SNN) is described herein. In contrast to a time-driven SNN, rather than simulating every moment of simulation time, the event-driven SNN attempts to find moments in simulation time where certain events occur, for example a neuron firing, and simulates only those moments. The network may be implemented on a single field-programmable gate array (FPGA), Application Specific Gate Array (ASIC), or the like, and can simulate any deterministic or stochastic spiking neural network with regular topology (i.e. with a repetitive connection pattern). As will be discussed further below, for the sake of efficiency, synaptic weights are evaluated on-the-fly with a non-linear transformation of the input features respectively associated with every neuron. It should however be understood that, in some embodiments, irregular topologies and plasticity may be implemented using an external memory to store synaptic weights and delays. In addition, multi-FPGA or multi-ASIC implementation may be used to increase the size of the simulated neural network.

The SNN is based on a pipelined comparator used to find the next neuron to fire (as per the event-driven simulation strategy), with each neuron having a firing time associated therewith. The neuron's discharge is then processed by updating the post-synaptic neurons affected by the firing event. The architecture can be duplicated or otherwise scaled to increase the performance of the system. The system may also use synchrony processing for efficient event-driven simulation (SPEEDS) to allow temporal jumps when there is no activity within the spiking neural network and parallel computations when many events are processed at a specific timestep. Since the computational power is mostly used towards spike processing (rather than membrane potential updates), the system significantly improves efficiency as compared to time-driven implementations.

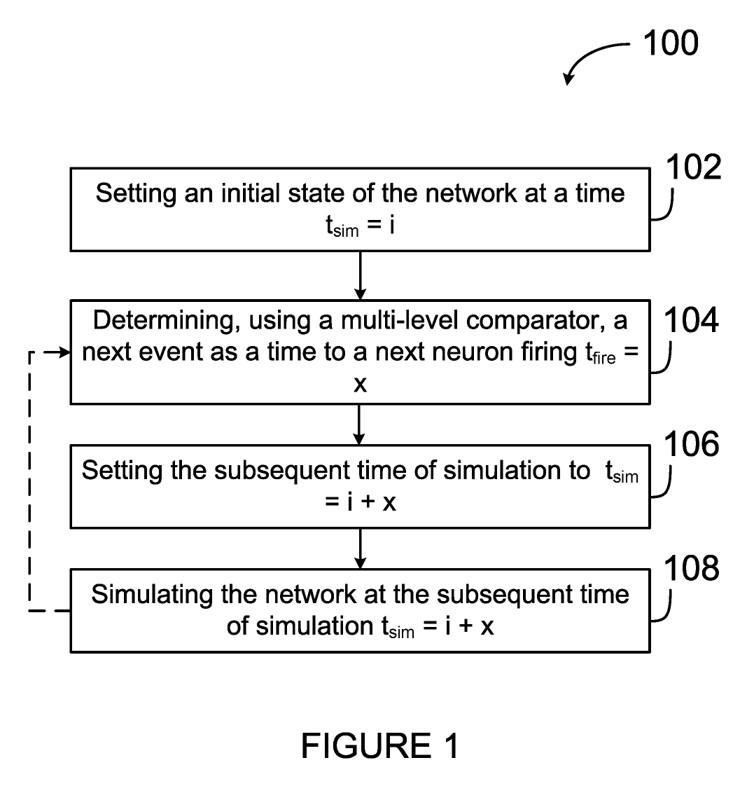

With reference to FIG. 1, there is shown a method 100 for operating an event-driven SNN. At step 102, an initial state of the neural network is set at a time tₛᵢₘ=i. This may include creating one or more neurons, one or more connection parameters between the neurons, and providing one or more inputs to the one or more neurons. In some embodiments, each neuron is provided with an initial value, for example an initial charge level. In some embodiments, the connections between the neurons, called ‘synapses’, are provided with weights which define the relationship between neurons connected by the synapses. The weights are indicative, for example, of a degree to which charge from a pre-synaptic neuron is passed on to a post-synaptic neuron when the pre-synaptic neuron discharges.

At step 104, a next event in the network is determined using a pipelined comparator. The determination is made by performing successive comparisons of neuron firing times to find the closest neuron firing time t_{fire}=x. At step 106, the subsequent time of simulation tₛᵢₘ=i+x is set based on the next neuron firing time t_{fire}=x determined at step 104, and the next simulation of the network occurs at time tₛᵢₘ=i+x., as per step 108. Simulating the network at the subsequent time of simulation comprises processing the event, such as the firing of a neuron, and applying the discharge of the neuron to all post-synaptic neurons associated with the firing neuron.

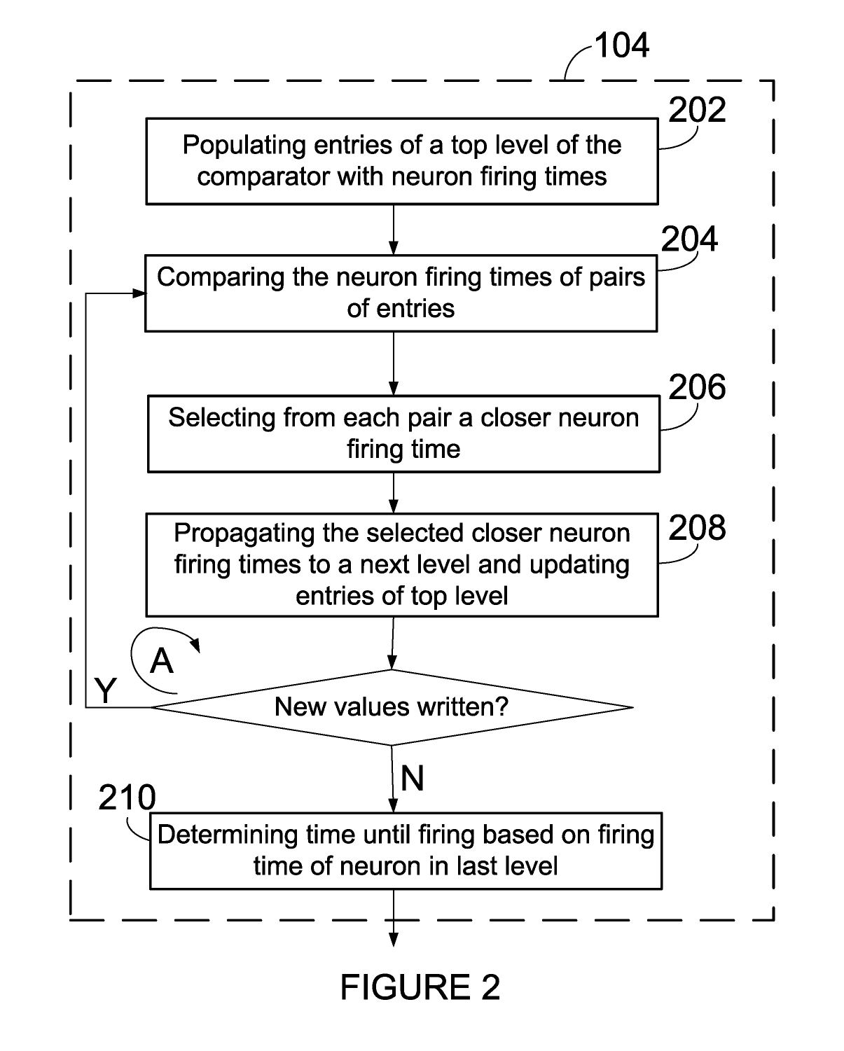

With reference to FIG. 2, certain embodiments of step 108 for determining a next event in the network are illustrated. At step 202, a top level of the pipelined comparator is populated with the next neuron firing times of neurons in the network. The comparator may be any device that takes two values as input and determines whether one value is greater than, less than or equal to the other value. Each level of the comparator is composed of at least one entry. Once the number of entries of a top level has been set, the number of entries of each next level is half the number of entries of each previous level.

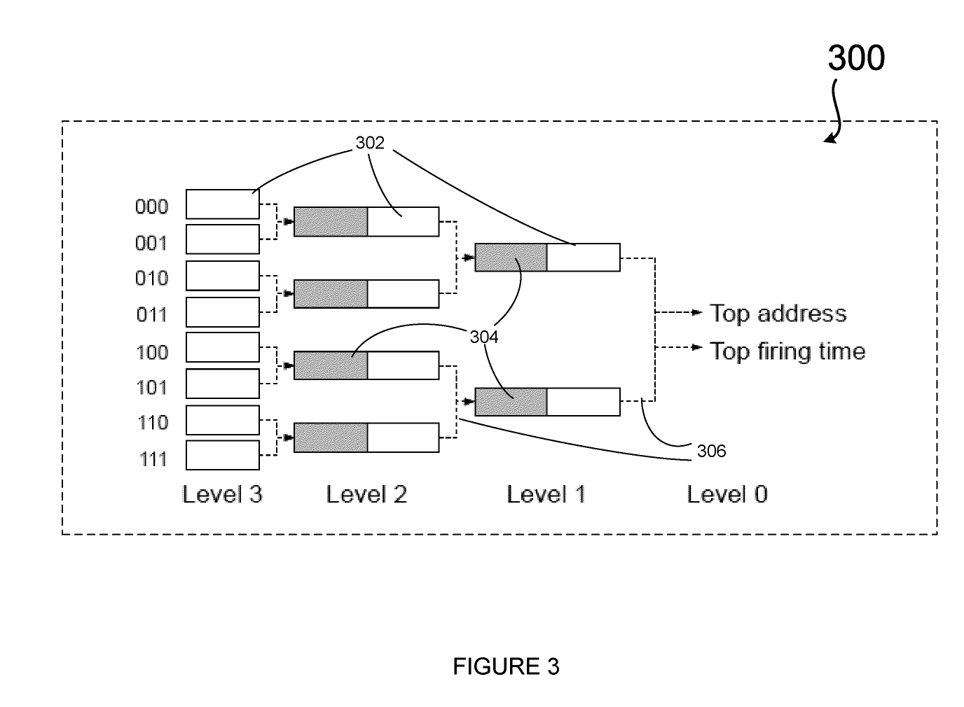

For example, and referring to FIG. 3, there is illustrated a comparator tree 300 having four levels and eight entries in a top level. The top level (Level 3) having eight entries leads to a next level (Level 2) having four entries, the subsequent level (Level 1) having two entries, and the final level (Level 0) having one entry. The number of entries of the top level may vary. The number of levels is related to the number of entries of the top level. In particular, with N entries in the top level, the comparator has log₂ (N) levels, plus a base level. In some embodiments, a single comparator is used and the number of entries of the top level is equal to the number of neurons in the network. In other embodiments, multiple comparators are used, each comparator having a number of top level entries corresponding to a fraction of the total number of neurons. The final level of each comparator may then become an entry of the top level of a final comparator so that a single entry remains at the last level of the final comparator.

Each entry is populated with a value representative of a neuron firing time for a given neuron. In some embodiments, the comparator is originally empty and each entry of the top level in the comparator is populated. In other embodiments, one or more of the entries are already populated, and only empty entries are populated. In further embodiments, all entries are already populated, and execution of step 202 causes one or more of the entries to be overwritten.

In FIG. 3, unshaded rectangles as in 302 correspond to memory locations containing firing times while shaded rectangles 304 correspond to memory locations containing address bits used to keep track of the next neuron to fire. Dashed lines as in 306 are used to represent the possible comparisons between pairs of entries for every level of the pipelined comparator tree 300.

In some embodiments, the neuron firing times are stored in the top level of the comparator tree 300 and the subsequent levels (e.g. levels 2, 1, and 0 of FIG. 3) are only used to store intermediate values for keeping track of the next neuron to fire. Also, in some embodiments, each level contains one combinational comparator (not shown) that is used to determine the next neuron to fire between two neurons, using the firing times of the two neurons and the global simulation time. In some embodiments, the firing times of the neurons are located on RAM blocks provided in an FPGA. In another embodiment, the smallest levels (e.g. levels 0 and 1) of the comparator tree can be stored on distributed RAM to save memory space. Also, to ensure simultaneous access to adjacent memory locations, the neurons located at even addresses may be stored on separate RAM blocks from those located at odd addresses.

At step 204, the neuron firing times of the pairs of entries for the levels of the comparator tree 300 are compared to one another. When only the top level of the comparator tree 300 has been populated, only the entries of the top level are compared.

At step 206, one entry from each pair is selected as having a closer neuron firing time. If the neuron firing times are identical, the selection may be performed at random, based on a default selection setting, or in any other suitable way.

At step 208, the selected neuron firing times from each pair (or a value representative of the neuron firing time or of the neuron associated with the neuron firing time) are propagated to a next level. In other words, those neurons which were selected at step 206 are “promoted” to the next level of the comparator, and the entries of the next level of the comparator tree are populated with values from the selected neurons. In addition, the entries of the top level are updated with one or more values.

Propagation may occur at each clock cycle or using any other measure of time. Initially, before all levels of the comparator tree 300 have been filled, propagation consists in selecting the closest firing time of each pair of entries and writing those values to a next level. When enough clock cycles have gone by such that all levels have been filled, comparisons may still be effected between pairs where one or both values have been updated at a previous iteration. If a comparison does not result in a change in the value of the next level, then no new value is written for that entry and the previous value is retained. If all top level entries are updated and no new values are written to any level, then a closest firing time is found in the entry of the last level and the method 104 moves on to step 210. At step 210, a time until firing is determined based on the firing time of the neuron in the last level.

Steps 204, 206, and 208 are shown to form loop A, which is repeated until the condition for outputting the closest firing time has been met. At the first iteration of loop A, only the top level contains values. At each subsequent iteration of loop A, an additional level is populated with values and values of the top level may be updated. It may be that only a single new value is written in the top level at any given iteration of loop A. It may also be that no new value is written in the top level at any given iteration of loop A and one or more new values are written at another level of the comparator tree 300. Each step of loop A may be performed concurrently for multiple levels of the comparator tree 300 at each clock cycle in a pipeline fashion. When no new values are written and all entries are updated, the method 104 exits loop A and moves on to step 210. The time until firing of the neuron in the last level is then used to set the subsequent time of simulation of the network, as per step 106 of method 100.

In order to use the pipelined comparator tree 300, the structure is first filled with the initial firing time of every neuron of the network, as per step 202. Each time a neuron is given a firing time, a comparison between the newly written value and the value located on the adjacent memory space (i.e. the value with the same address but with the least significant bit (LSB) inverted) is executed to find the next neuron to fire, as per steps 204 and 206. The resulting firing time is then stored on the next clock cycle in the next level of the comparator along with the least significant bits of the address, as per step 208. As discussed above, if two neurons have the same firing time, any one of them can be promoted to the next level. The same process is then repeated in a pipelined fashion during the following clock cycles until the final level of the comparator (i.e. level 0) is reached. Once every value is written in the comparator and a latency of one clock cycle per level has elapsed, the comparator tree of FIG. 3 is filled

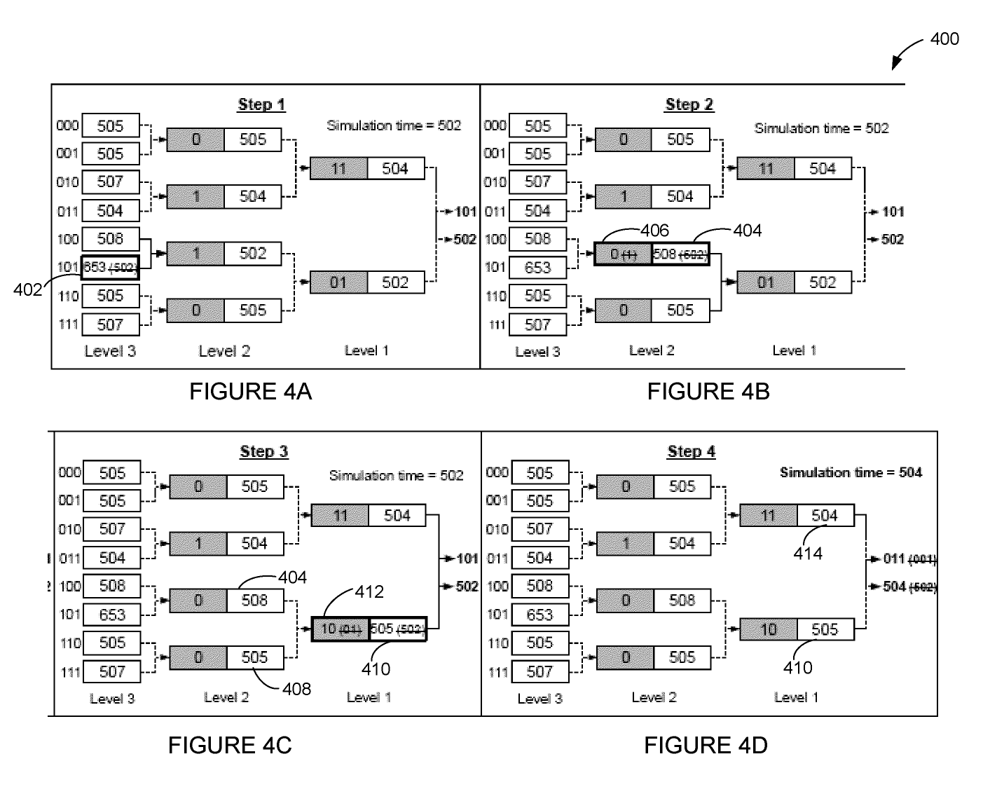

FIGS. 4A-D illustrate an example 400 of loop A with a filled pipelined comparator tree 300. The comparator tree 300 is used in a spiking neural network of eight (8) neurons, and the example 400 shows the manner in which processing is handled in the comparator. With reference to FIG. 4A, in the first step, the firing time value (502) located at address 101 (block 402 at level 3) is overwritten by the value 653. Although the example shown in FIG. 4A illustrates the firing time value located at address 101 as being overwritten, it should be understood that the firing time value located at any address or addresses other than 101 may be overwritten. Also, the value 653 is provided for illustrative purposes only and it should be understood that any other suitable firing value may apply.

With reference to FIG. 4B, during the second step, the highest priority value between the one at address 100 and the one at address 101 of level 3 (e.g. the smallest value between 508 and 653, which corresponds to the next neuron to fire) is written in the second level of the comparator, at block 404. The least significant bit of the address of the highest priority value, e.g. the least significant bit of the address 100, is also written in the second level of the comparator tree, at block 406.

With reference to FIGS. 4C and 4D, in the third and fourth stages, similar comparisons are performed adding one address bit at each level. In FIG. 4C, the highest priority value between the value written in block 404 and the value written in block 408 of level 2, namely the smallest value between 505 and 508, is written in level 1 of the comparator, at block 410. The two least significant bits of the address of the highest priority value, e.g. the two least significant bits of the address 110, which is the address corresponding to the highest priority value of 505, are also written in level 1 of the comparator, at block 412. Similarly, in FIG. 4D, the highest priority value between the value written in block 410 and the value written in block 414 of level 1, namely the smallest value between 505 and 504, is written. The three least significant bits of the address of the highest priority value, e.g. the three least significant bits of the address 011, which is the address corresponding to the highest priority value of 504, are also written. At this stage, no new values are written to any level and therefore, the output neuron corresponds to the one with the highest priority value and its firing time will be the next simulation time.

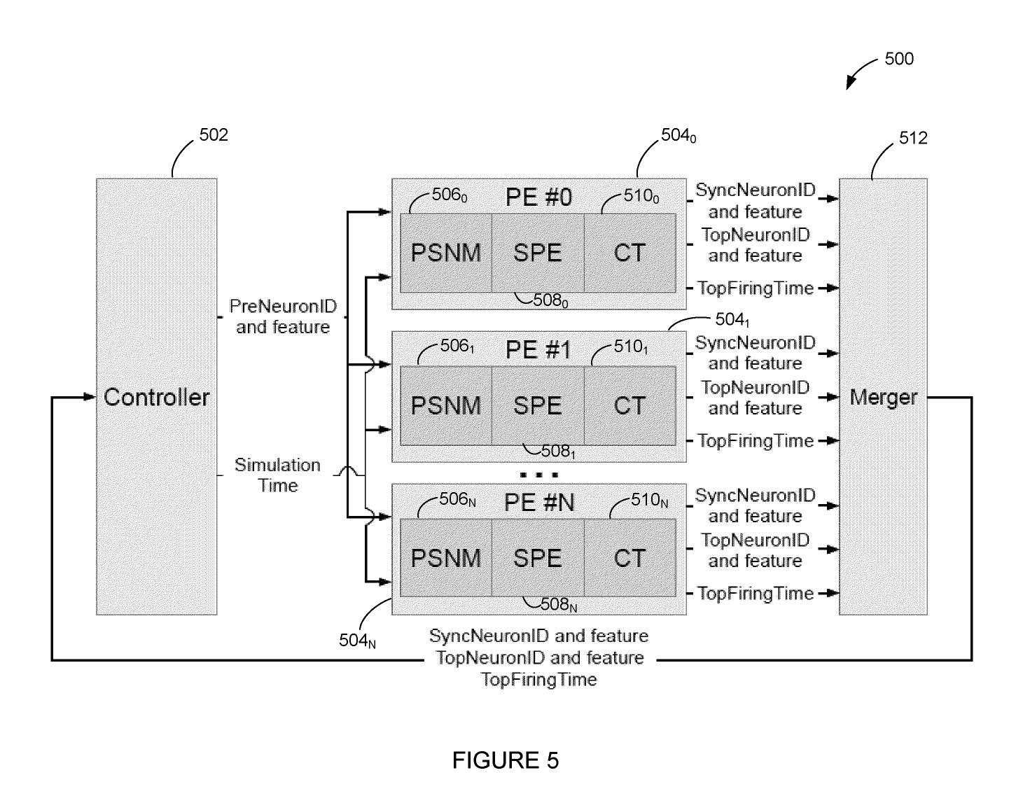

With reference to FIG. 5, there is illustrated a system 500 for implementing the SNN as described herein, in accordance with some embodiments. In particular, neurons of the network are evenly distributed among a number N of banks, where N is a power of 2. As can be seen in FIG. 5, the system 500 comprises a controller unit 502 having an output that is connected to each one of a plurality (N) of pipelined processing elements (or units) (PE) 504₀, 504₁, . . . , 504_{N}. The processing elements 504₀, 504₁, . . . , 504_{N} may be any device that can perform operations on data. Examples are a central processing unit (CPU), a microprocessor, a front-end processor, and the like. Each processing element 504₀, 504₁, . . . , 504_{N} comprises a pre-synaptic neuron memory (PSNM) 506₀, 506₁, . . . , 506_{N}, a synaptic processing element (or unit) (SPE) 508₀, 508₁, . . . , 508_{N}, and a comparator tree (CT) 510₀, 510₁, . . . , 510_{N}, corresponding to the comparator tree 300 described hereinabove. A merger unit 512 is further provided and connected to an output of each processing element 504₀, 504₁, . . . , or 504_{N}. The output of the merger unit 512 is in turn connected to the input of the controller unit 502. As will be discussed further below, the controller unit 502 and the merger unit 512 are used to direct neurons towards the proper processing elements 504₀, 504₁, . . . , 504_{N}.

Each processing element 504₀, 504₁, . . . , 504_{N} handles a given one of the N banks (i.e. a given number of neurons, with all processing elements 504₀, 504₁, . . . , 504_{N} processing the same number of neurons) and performs all tasks required to update the neurons of a single bank using data from the pre-synaptic neuron and the simulation time. These tasks include, but are not limited to, finding the post-synaptic neurons for a given pre-synaptic neuron, spike processing, and neuron resetting. Synchrony processing for efficient event-driven simulation is implemented by sending the data associated with every neuron that will fire at the current simulation time to the pre-synaptic neuron memories 506₀, 506₁, . . . , 506_{N} for the purpose of improving overall efficiency. The best efficiency can indeed be achieved when all processing elements 504₀, 504₁, . . . , 504_{N} are computing neuron spikes in parallel.

The controller unit 502 is used to keep track of the current simulation time and feed the processing elements with pre-synaptic neurons firing at that precise time. Once in each processing element 504₀, 504₁, . . . , or 504_{N}, the identifiers (i.e. ID numbers) of the pre-synaptic neurons are stored, along with the corresponding features, in the pre-synaptic neuron memory 506₀, 506₁, . . . , or 506_{N} of the given processing element 504₀, 504₁, . . . , or 504_{N}. As used herein, the term “feature” refers to a characteristic that allows to dynamically compute the synaptic weight between a pre-synaptic neuron and a given post-synaptic neuron for purposes of saving memory space. It should however be understood that, in some embodiments, the synaptic weight of each neural connection (i.e. associated with each pair of neurons) may be stored in memory, thereby alleviating the need to store features associated with neurons and dynamically compute the synaptic weight. In this case, learning can be implemented in the spiking neural network by modifying the stored weights over the course of the simulation.

Each pre-synaptic neuron memory 506₀, 506₁, . . . , or 506_{N} is a buffer that serially feeds the synaptic processing element 508₀, 508₁, . . . , or 508_{N} of each processing element 504₀, 504₁, . . . , or 504_{N}. The synaptic processing element 508₀, 508₁, . . . , or 508_{N} then uses the data received from the pre-synaptic neuron memory 506₀, 506₁, . . . , or 506_{N} to compute the impact of spikes on the post-synaptic neurons. The synaptic processing element 508₀, 508₁, . . . , or 508_{N} is also used to implement synchrony processing for efficient event-driven simulation by detecting post-synaptic neurons that are synchronized with the actual pre-synaptic neuron (i.e. neurons from separate processing elements 504₀, 504₁, . . . , 504_{N} that will fire at the same time). For this purpose, the synaptic processing element 508₀, 508₁, . . . , or 508_{N} checks whether one or more neurons are synchronized with the neuron identified in the processing element 504₀, 504₁, . . . , or 504_{N} as possibly being the next neuron to fire. When synchronized neurons are identified, each processing element 504₀, 504₁, . . . , 504_{N} associates an identifier (referred to as “SyncNeuronID”) with each synchronized neuron for identification thereof. In order to allow parallel computations, each synchronized neuron is then redirected to the pre-synaptic neuron memories 506₀, 506₁, . . . , 506_{N} via the merger unit 512 and the controller unit 502. In this manner, synchrony processing for efficient event-driven simulation can be implemented, thereby significantly increasing the number of neurons that can be processed at any given time.

The comparator tree 510₀, 510₁, . . . , or 510_{N} is used at the end of each processing element 504₀, 504₁, . . . , or 504_{N} to find the next neuron to fire in each bank as the neuron firing times are updated. Each comparator tree 510₀, 510₁, . . . , or 510_{N} outputs an intermediate single entry corresponding to the next neuron to fire in each bank. When all the pre-synaptic neuron memories 506₀, 506₁, . . . , or 506_{N} are empty, the merger unit 512, which uses the same comparator tree structure as the one used in each comparator tree 510₀, 510₁, . . . , or 510_{N}, finds the next neuron to fire from the outputs of all the comparator trees 510₀, 510₁, . . . , 510_{N}. The intermediate single entries output from the comparator trees 510₀, 510₁, . . . , or 510_{N} are thus input to the merger unit and set as the entries of a top level of another comparator tree (not shown) and outputs at its final level a final single entry which corresponds to the next neuron to fire. This next neuron to fire, which is identified by its ID number (“TopNeuronID”), cycles back from the merger unit 512 to the controller unit 502 along with its firing time (“TopFiringTime”) and feature and will be used for a new simulation cycle. In the new cycle, the controller unit 512 sends the received information to the processing elements 504₀, 504₁, . . . , 504_{N} as the identifier (“PreNeuronID”) and feature of the pre-synaptic neuron. The information provided by the controller unit 502 indicates which neuron just fired and is used by the processing elements 504₀, 504₁, . . . , 504_{N} to determine the neurons that are affected by the neuron discharge and that should accordingly be updated.

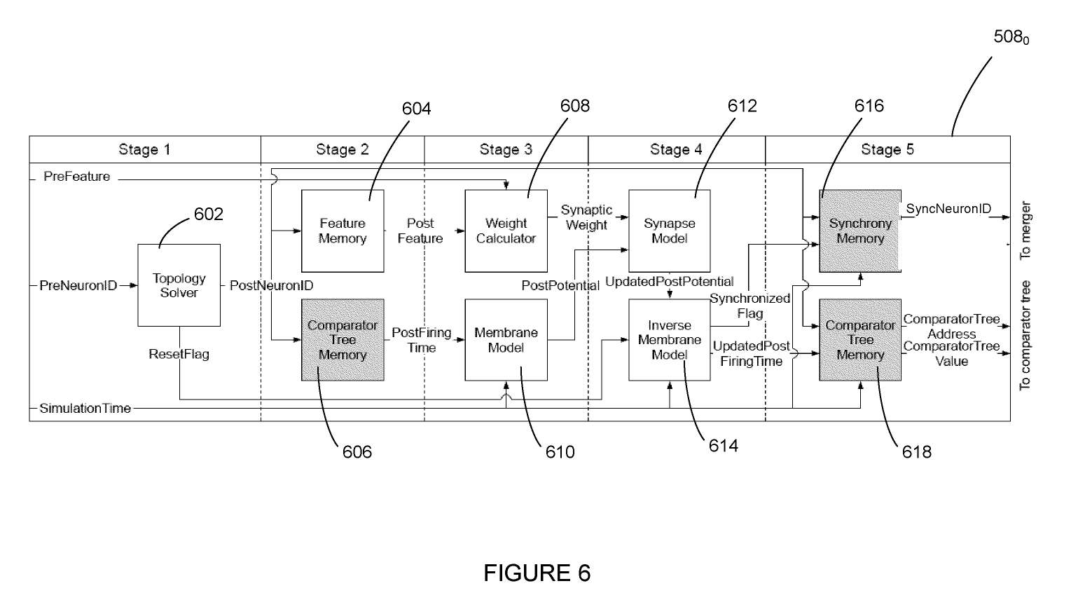

FIG. 6 illustrates a given one of the pipelined synaptic processing elements, namely synaptic processing element 508₀. Although only synaptic processing element 508₀ is shown and described herein, it should be understood that remaining synaptic processing elements 508₁, . . . , 508_{N} have similar components and operation as synaptic processing element 508₀. The illustrated pipelined synaptic processing element 508₀ is a five-stage pipeline that can process a spike or a neuron reset every clock cycle with an overall latency of five (5) clock cycles (i.e. one clock cycle per stage). The synaptic processing element 508₀ comprises a topology solver 602 in the first stage, a feature memory 604 and a comparator tree memory 606 in the second stage, a weight calculator 608 and a membrane model 610 in the third stage, a synapse model 612 and an inverse membrane model 614 in the fourth stage, and a synchrony memory 616 and a comparator tree memory 618 in the fifth stage. Note that while illustrated separately, comparator tree memory 606 and comparator tree memory 618 are a same instance of a comparator tree memory.

In the first stage, the topology solver 602 uses an identifier (e.g. ID number, referred to as “PreNeuronID” in FIGS. 5 and 6) of the pre-synaptic neuron, as obtained from the controller unit 502, to find all possible post-synaptic neurons associated with the pre-synaptic neuron. In the embodiment where the implementation is used for neural networks with regular topologies, the topology solver 602 is implemented as a finite-state machine that sequentially generates all post-synaptic neuron ID numbers (referred to as “PostNeuronID” in FIG. 6) required for processing. The topology solver 602 further generates a “ResetFlag” that can be used to reset a given neuron upon the neuron discharging. When resetting of a neuron is required, the ResetFlag is sent to the inverse membrane model 614, whose operation will be discussed further below.

In the second stage, the feature memory 604 receives the post-synaptic neuron ID number from the topology solver 602 and extracts the feature (referred to as “PostFeature” in FIG. 6) attached to the post-synaptic neurons. The comparator tree memory 606, which corresponds to the largest level of the comparator tree, also receives the post-synaptic neuron ID number from the topology solver 602 and reads the comparator tree memory to retrieve the firing time of the post-synaptic neuron (referred to as “PostFiringTime” in FIG. 6), as per step 404.

In the third stage, the features, i.e. the feature attached to the post-synaptic neuron (PostFeature) obtained from the feature memory 604 and the feature attached to the pre-synaptic neuron (referred to as “PreFeature” in FIG. 6) obtained from the controller unit 502, are used by the weight calculator 608 to generate the synaptic weight (referred to as “SynapticWeight” in FIG. 6). In one embodiment, the weight calculator 608 dynamically computes the synaptic weight from the received features, e.g. determines the synaptic weight required for establishing a connection between the pre-synaptic neuron and the post-synaptic neuron in accordance with the respective features thereof. In another embodiment, the weight calculator 608 uses identifiers of the pre-synaptic and post-synaptic neurons (e.g. PreNeuronID and PostNeuronID) in a look-up table to obtain the synaptic weight. The membrane model 610 further receives the firing time of the post-synaptic neuron from the comparator tree memory 606 and determines the potential value (referred to as “PostPotential” in FIG. 6) of the post-synaptic neuron using a look-up table that implements the following equation:

$${p}_{i} ( t ) = \frac{{I}_{0}}{τ} ( 1 - {e}^{- t / τ} ) \qquad ( 1 )$$

where pᵢ(t) is the membrane potential of neuron i at time t, I₀ is the input current and τ is the membrane time constant. Equation (1) describes the evolution of the membrane potential of an isolated leaky integrate-and-fire neuron with an initial potential of 0 V. It should however be understood that invertible equations other than equation (1) could also be used to embody the evolution of the membrane potential.

In the fourth stage, combinational logic is used in the synapse model 612 to sum of the synaptic weight (indicative of an increase or decrease in the neuron's potential value) and the potential value of the post-synaptic neuron. The result, which is referred to as “UpdatedPostPotential” in FIG. 6 and is indicative of the impact of the firing event on the post-synaptic neuron, is then transferred to the inverse membrane model 614. In this manner, the updated firing time (referred to as “UpdatedPostFiringTime” in FIG. 6) can be retrieved at the inverse membrane model 614 using a look-up table that implements the following equation:

$${t}^{0 -> p} = - τ ln ( 1 - \frac{p τ}{{I}_{0}} ) \qquad ( 2 )$$

where t^{0→p} is the time it takes for a neuron with an initial potential of 0 V to reach the potential p assuming a constant I₀. Equation (2) is an inverse of equation (1) and allows to find the time at which a certain potential is reached after a previous spike when the potential is reset to 0 V. It should again be understood that an inverse membrane model equation, which is different from equation (2) and would correspond to another membrane potential than the one discussed above with reference to equation (1), could apply.

The membrane model 610 and the inverse membrane model 614 also receive the simulation time (referred to as “SimulationTime” in FIG. 6) obtained from the controller unit 502. This simulation time is used to determine the simulation time at which the neuron will fire next, using the following equation:

tₛ(t)=t+t^{0→p}^{^{θ}}−t^{0→p(t)} (3)

where tₛ(t) is the neuron's next firing time, t is the current simulation time, and t^{0→p}^{^{θ}}is the time it takes for a neuron with a potential of 0 V to reach its threshold potential p^{θ}.

The inverse membrane model 614 further outputs a flag, referred to as “SynchronizedFlag” in FIG. 6, which is activated when it is determined that the neuron will fire at the current simulation time, i.e. the values of UpdatedPostFiringTime and SimulationTime are equal. This allows to detect that the post-synaptic neuron will fire at the same time as the pre-synaptic neuron and causes the post-synaptic neuron to be sent back to the controller unit (reference 502 in FIG. 5) for redirecting towards a given processing element (references 504₀, 504₁, . . . , 504_{N} in FIG. 5). As discussed above, this allows parallel computations and synchrony processing.

The fifth stage of the pipeline contains the synchrony memory 616, which is used to store the ID numbers of the synchronized post-synaptic neurons, prior to transmission to the controller unit (reference 502 in FIG. 5). The synchrony memory 616 receives the post-synaptic neuron ID number from the topology solver 602, the synchronized flag, and the simulation time and outputs to the merger unit (reference 512 in FIG. 5) the SyncNeuronID identifier that is associated with the synchronized neuron. The information output by the synchrony memory 616 is indicative of whether synchronized neurons, and particularly post-synaptic neurons that are synchronized with the actual pre-synaptic neuron, have been detected. In one embodiment, this operation is used to implement synchrony processing for efficient event-driven simulation by sending synchronized neurons towards the controller unit 502. At the fifth stage, the updated firing time of the post-synaptic neurons (as received from the inverse membrane model 614) is also written into the comparator tree memory 618. The comparator memory 618 also receives the simulation time and the post-synaptic neuron ID number and outputs the address (“ComparatorTreeAddress”) and value (“ComparatorTreeValue”) of the comparator tree (as in 510₀) to which the synaptic processing element (as 508₀) is connected.

In one embodiment, the read operation performed in the second stage and the write operation performed in the fifth stage are executed in parallel using dual-port Random-access memory (RAM) blocks provided in the FPGA. However, it may be desirable for a validity check to be performed in the second stage to stall the pipeline if a read operation is performed on a post-synaptic neuron that is currently being updated in the third, fourth or fifth stage. This may be done by setting an invalidity bit when the firing time value is read in the second stage and by resetting the invalidity bit when the firing time value is written back to memory in the fifth stage. This is analogous to a Read-After-Write (RAW) hazard handling in microprocessor pipelines. Also, to ensure that a synchronized neuron is not detected twice when using synchrony processing, a synchrony check may be performed in the same manner by setting a synchrony bit when a synchronized pre-synaptic neuron is detected and by resetting it when the neuron's potential is reset during a following computation. In one embodiment, the synchrony bit is read from the comparator tree memory 606 at the second stage of the pipelined synaptic processing element at the same time as the value of the PostFiringTime parameter, with the synchrony bit being concatenated with PostFiringTime. The synchrony bit may then be delayed and sent to the inverse membrane model 614. If the synchrony bit is equal to 1, synchrony detection is disabled to avoid detecting the same neuron twice. Otherwise, if the synchrony bit is not set, i.e. equal to 0, synchrony detection will be performed on the neuron.

Referring again to FIG. 5, each pipelined comparator tree 510₀, 510₁, . . . , or 510_{N} is used to efficiently retrieve the next neuron to fire in the artificial spiking neural network. Since each synaptic processing element 508₀, 508₁, . . . , or 508_{N} can update up to one neuron firing time per clock cycle, each pipelined comparator tree 510₀, 510₁, . . . , or 510_{N} processes updates at the same rate with minimum latency and logic resources.

At this point, the comparator tree 300 is ready to be used in the global architecture of the system 500. Each time a value is written in the comparator tree memory 518 of one of the synaptic processing elements 508₀, 508₁, . . . or 508_{N}, the value is written in the leftmost level of the pipelined comparator tree 300. The newly written value then goes through the same processing steps described in conjunction with FIGS. 4A-D and updates the intermediate values stored in the subsequent levels on the next clock cycles. Using the system 500, the output values are the ones corresponding to the next neuron to fire as long as the latency of one clock cycle per level has elapsed.

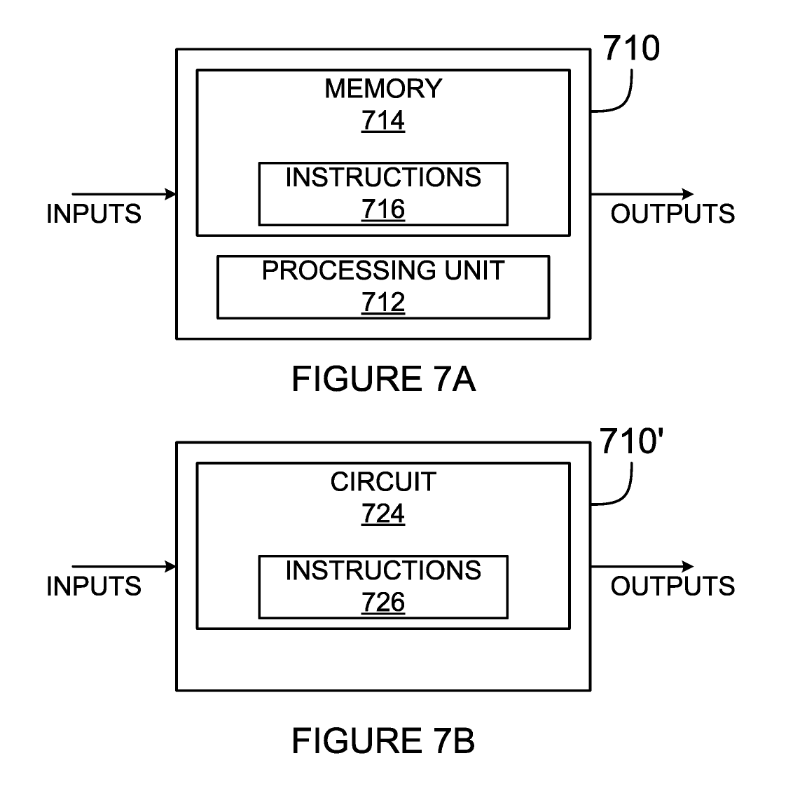

FIG. 7A shows a schematic representation of an example implementation of the methods 100, 200 as a combination of software and hardware components. A computing device 710 is illustrated with one or more processing units (referred to as “processing unit 712”) and one or more computer-readable memories (referred to as “memory 714”) having stored thereon program instructions 716 configured to cause the processing unit 712 to generate one or more outputs based on one or more inputs. The inputs may comprise one or more signals representative of the inputs to the SNN, to the comparator, and the like. The outputs may comprise one or more signals representative of the state of the simulation of the SNN, of the subsequent time of simulation, and the like.

The processing unit 712 may comprise any suitable devices configured to cause a series of steps to be performed so as to implement the computer-implemented methods 100, 200 such that instructions 716, when executed by a computing device 710 or other programmable apparatus, may cause the functions/acts/steps specified in the methods described herein to be executed. The processing unit 712 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 714 may comprise any suitable known or other machine-readable storage medium. The memory 714 may comprise non-transitory computer readable storage medium such as, for example, but not limited to, an electronic, magnetic, optical, electromagnetic, infrared, or semiconductor system, apparatus, or device, or any suitable combination of the foregoing. The memory 714 may include a suitable combination of any type of computer memory that is located either internally or externally to device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory may comprise any storage means (e.g., devices) suitable for retrievably storing machine-readable instructions executable by processing unit.

FIG. 7B shows a schematic representation of another example implementation of the methods 100, 200, as a combination of analog and/or digital circuit components in a circuit assembly 710′. One or more circuits (referred to as “circuit 724”) are configured to generate one or more outputs based on one or more inputs in accordance with instructions 726 hardcoded in the circuit 724. The inputs may comprise one or more signals representative of the inputs to the SNN, to the comparator tree, and the like. The outputs may comprise one or more signals representative of the state of the simulation of the SNN, of the subsequent time of simulation, and the like.

Table 1 below lists the resources for several implementations of the system 500 in terms of six-input look-up tables (LUTs), flip-flops (FFs), slices and block RAMs (BRAMs). When comparing the last three columns, it can be noted that the resource usage does not increase significantly with the addition of neurons since the comparator tree structure is well distributed among the processing elements. Also, comparison between the first two columns shows that the system 500 is scalable since the number of BRAMs is proportional to the number of neurons.

TABLE 1
Resource usage for several implementations of the
spiking neural network using a XC6VLX240T FPGA

| | 1-bank | 1-bank | 2-bank | 4-bank |
|---|---|---|---|---|
| | 2¹⁶ neurons | 2¹⁷ neurons | 2¹⁷ neurons | 2¹⁷ neurons |
| FFs | 2 149 (0.7%) | 2 245 (0.7%) | 3 837 (1.2%) | 6 854 (2.3%) |
| LUTs | 3 052 (2.0%) | 3 160 (2.1%) | 5 537 (3.7%) | 10 447 (6.9%) |
| Slices | 1 571 (4.2%) | 1 677 (4.5%) | 3 119 (8.3%) | 5 570 (14.8%) |
| BRAMs | 205 (25.6%) | 389 (46.8%) | 410 (49.3%) | 460 (55.3%) |

To test an embodiment of the system 500, an image segmentation application was performed. Features f, which are pixel values of an input gray-scale image, were associated to every neuron in the network and connections were made using an eight-neighbor topology. Synaptic weights wᵢⱼ between neurons i and j were computed using the following equation:

$${w}_{ij} = {w}_{max} \times ( 1 - \frac{1}{1 + {e}^{- ( α ( \vert {f}_{i} - {f}_{j} \vert - δ ) )}} ) \qquad ( 4 )$$

where parameters wₘₐₓ=255, α=100 and δ=4. With the system 500, a strong synaptic weight corresponds to two adjacent neurons having a similar grayscale level while a weak synaptic weight corresponds to two adjacent neurons having different grayscale levels. Also, neurons were provided with the same parameters but were initialized with random membrane potentials.

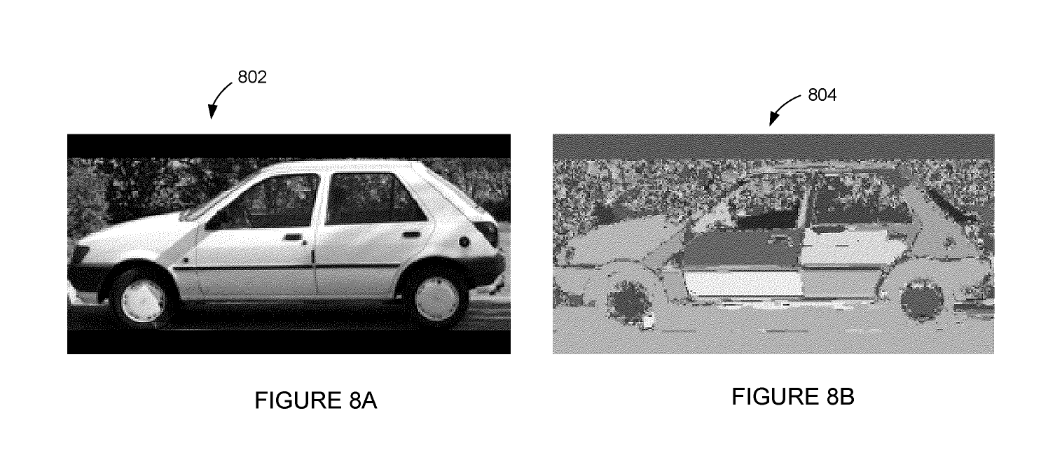

FIG. 8 illustrates an original image 802 and a segmented image 804 of a car, the images comprising 512 by 256 pixels. As can be seen in FIG. 8, after simulation, neurons associated to pixels of the same segment tend to synchronize and synchronized neurons are represented by the same color in the image 804.

The spiking neural network used for image segmentation was tested using 1-bank, 2-bank, and 4-bank architectures. The impact of synchrony processing (SPEEDS) was also evaluated by disabling such processing in some experiments. For each case, the average performance (in spikes per second) of the implementation was measured on a system clocked at 100 MHz. The results are shown in Table 2 below.

TABLE 2
Performance of the system with and without
synchrony detection for image segmentation

| | 1-bank | 2-bank | 4-bank |
|---|---|---|---|
| | 2¹⁷ neurons | 2¹⁷ neurons | 2¹⁷ neurons |
| SPEEDS disabled | 14.1 Mspikes/s | 15.1 Mspikes/s | 16.8 Mspikes/s |
| SPEEDS enabled | 36.2 Mspikes/s | 55.8 Mspikes/s | 72.4 Mspikes/s |

The results of Table 2 show that the event-driven simulation of a spiking neural network implemented on an FPGA can be affected by the parallel computational capability of hardware digital resources. These parallel computations are achieved by processing synchronized events on separate processing elements. The performance is improved as the number of banks is increased but the magnitude of this improvement depends on the topology of the spiking neural network itself.

In another example implementation, an image matching application was implemented. In the image matching application, a first sub-SNN is used for processing a test image and a second sub-SNN is used to represent the reference image. Bidirectional connections are established between these two sub-networks which causes neurons representing similar segments to synchronize.

Like in the image segmentation application, the neurons are provided an identifier, with the most significant bit of the identifier being representative of the sub-network to which the neuron belongs. The neurons are distributed into N banks as with the image segmentation application. The size of the sub-networks is dependent on the number of segments of the image being matched. In this example implementation, the topology solver establishes the bidirectional connections between the sub-networks. The topology solver associated with a given bank is also configured for only mapping post-synaptic neurons which are located within the associated bank.

Each neuron is associated with two values, namely an average grey level and a compactness of the segment. These values are stored in memory and are used when computing the synaptic weight. Specifically, the synaptic weight is calculated for both values for pre- and post-synaptic neurons, then the smaller of the two weights is assigned as the synaptic weight, following a fuzzy logic “AND” operation. Therefore, in this example implementation, a high synaptic weight will only be assigned if the neurons have both similar average grey levels and similar compactness. A synchrony detection module is used to evaluate a number of synchronized neuron pairs across both sub-networks, and if the number surpasses a predetermined threshold, the image matching application indicates a match to the reference image.

Table 3 below lists the resources for several implementations of the proposed system in terms of FFs, LUTs, slices, and BRAMs for use in an image matching application. The results illustrate that, in this embodiment, fewer memory components are required for performing the matching than are required for the segmentation described hereinabove. Additionally, doubling the number of neurons does not double the memory requirements, due to the granularity of the memory.

TABLE 3
Resource usage for several implementations of an image
matching application using the spiking neural network

| | 1-bank | 1-bank | 2-bank | 4-bank |
|---|---|---|---|---|
| | 128 neurons | 256 neurons | 256 neurons | 256 neurons |
| FFs | 2 149 (0.7%) | 2 245 (0.7%) | 3 837 (1.2%) | 6 854 (2.3%) |
| LUTs | 3 052 (2.0%) | 3 160 (2.1%) | 5 537 (3.7%) | 10 447 (6.9%) |
| Slices | 1 571 (4.2%) | 1 677 (4.5%) | 3 119 (8.3%) | 5 570 (14.8%) |
| BRAMs | 205 (25.6%) | 389 (46.8%) | 410 (49.3%) | 460 (55.3%) |

Table 4 indicates that a performance of the image matching application increases as a number of complex neurons to evaluate increases. This is because a larger number of neurons means a larger number of post-synaptic neurons are generated for each evaluated neuron, which increases event speed for each evaluated neuron. Also, while SPEEDS had an effect on the image matching application, for this implementation it was not as significant as for the implementation of the image segmentation application discussed hereinabove.

TABLE 4
Performance of the system with and without synchrony
detection for image matching on one bank

| | 20 complex | 40 complex | 80 complex |
|---|---|---|---|
| | neurons | neurons | neurons |
| SPEEDS disabled | 41.7 Mspikes/s | 58.9 Mspikes/s | 74.1 Mspikes/s |
| SPEEDS enabled | 53.6 Mspikes/s | 71.9 Mspikes/s | 84.5 Mspikes/s |

While illustrated in the block diagrams as groups of discrete components communicating with each other via distinct data signal connections, it will be understood by those skilled in the art that the present embodiments may be provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

The system 500 described herein may be implemented in a high level procedural or object oriented programming or scripting language, or a combination thereof, to communicate with or assist in the operation of a computer system, for example the computing device 710 and/or the circuit assembly 710′. Alternatively, the system 500 may be implemented in assembly or machine language. The language may be a compiled or interpreted language. Program code for implementing the system 500 may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the system 500 may also be considered to be implemented by way of a non-transitory computer-readable storage medium having a computer program stored thereon. The computer program may comprise computer-readable instructions which cause a computer, or more specifically at least one processing unit of the computer, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Various aspects of the system and methods herein-disclosed may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A method for operating an event-driven neural network comprising a plurality of neurons, the method comprising:
(i) setting an initial state of the network;
(ii) determining a next event in the network as a time to a next neuron firing by:
(a) populating entries of a top level of at least one multi-level comparator with values representative of neuron firing times;
(b) comparing pairs of entries and selecting from each pair an entry having a closest neuron firing time;
(c) propagating the selected ones from each pair to a next level of the comparator and updating the entries of the top level with one or more new values;
(d) repeating steps (b) and (c) until all top level entries are updated and no new values are written to any level of the comparator; and
(e) determining the time to a next neuron firing based on the neuron firing time of the value in the final level;
(iii) setting a subsequent time of simulation to the next neuron firing time; and
(iv) simulating the network at the subsequent time of simulation.

2. The method of claim 1, wherein steps (b) and (c) are performed over one clock cycle.

3. The method of claim 1 or 2, further comprising repeating steps (ii) to (iv) iteratively during operation of the network.

4. The method of claim 1, wherein selecting from each pair an entry comprises promoting a random one of the entries of a pair when the associated neuron firing times are identical.

5. The method of claim 1, further comprising:
distributing the plurality of neurons across a plurality of processing elements each having a comparator, performing steps (a) to (d) in parallel in each one of the processing elements, and outputting intermediate values from the final level of each comparator of each processing element;
inputting the intermediate values into a merger unit having a comparator; and
performing steps (a) to (d) in the merger unit with the intermediate values set as top level entries.

6. The method of claim 5, further comprising storing data associated with every neuron that is about to fire in pre-synaptic neuron memories provided in each one of the processing elements.

7. The method of claim 5, further comprising:
identifying as synchronized neurons any neurons from separate processing elements that are set to fire at a same time; and
redirecting the synchronized neurons to a same processing element.

8. The method of claim 7, wherein the synchronized neurons are pairs of pre-synaptic and post-synaptic neurons.

9. The method of claim 1, wherein simulating the network at the subsequent time of simulation comprises:
finding post-synaptic neurons associated with pre-synaptic neurons ready to fire;
determining synaptic weights between the post-synaptic neurons and the pre-synaptic neurons ready to fire;
determining potential values of the post-synaptic neurons upon fire; and
updating next firing times and values for the pre-synaptic neurons and the post-synaptic neurons.

10. A spiking neural network comprising:
a memory having stored thereon program code executable by a processor; and
at least one processing unit configured for:
(i) setting an initial state of the network;
(ii) determining a next event in the network as a time to a next neuron firing by:
(a) populating entries of a top level of at least one multi-level comparator with values representative of neuron firing times;
(b) comparing pairs of entries and selecting from each pair an entry having a closest neuron firing time;
(c) propagating the selected ones from each pair to a next level of the comparator and updating the entries of the top level with one or more new values;
(d) repeating steps (b) and (c) until all top level entries are updated and no new values are written to any level of the comparator; and
(e) determining the time to a next neuron firing based on the neuron firing time of the value in the final level;
(iii) setting a subsequent time of simulation to the next neuron firing time; and
(iv) simulating the network at the subsequent time of simulation.

11. The system of claim 10, wherein steps (b) and (c) are performed over one clock cycle.

12. The system of claim 10 or 11, further comprising repeating steps (ii) to (iv) iteratively during operation of the network.

13. The system of claim 10, wherein selecting from each pair an entry comprises promoting a random one of the entries of a pair when the associated neuron firing times are identical.

14. The system of claim 10, wherein the at least one processing unit comprises:
a controller;
a merger unit having one of the at least one comparator and connected to the controller unit; and
a plurality of processing elements, each one of the processing elements having an output connected to an input of the merger unit and having an input connected to an output of the controller unit for receiving from the controller unit a pre-synaptic neuron discharging in a current simulation cycle, each one of the processing elements comprising at least one of the at least one comparator and configured to perform steps (a) to (d) in parallel and output intermediate values from the final level of each comparator of each processing element;
the merger unit configured for receiving the intermediate values from the plurality of processing units, performing steps (a) to (d) with the intermediate values set as top level entries in the comparator of the merger unit, and sending the neuron firing time of the value in the final level to the controller unit for processing new pre-synaptic neurons and updating the current simulation cycle.

15. The system of claim 14, wherein each one of the processing elements comprises a memory for storing data associated with every neuron that is about to fire.

16. The system of claim 14, wherein each one of the processing elements comprises a synaptic processing unit configured to identify as synchronized neurons any neurons from separate processing elements that are set to fire at a same time and to cause the controller unit to redirect the synchronized neurons to a same processing element.

17. The system of claim 14, wherein each one of the processing elements is pipelined to perform a series of operations over a number of clock cycles.

18. The system of claim 17, wherein the number of clock cycles is five.

19. The system of claim 17, wherein the series of operations comprise:
finding post-synaptic neurons associated with pre-synaptic neurons ready to fire;
determining synaptic weights between the post-synaptic neurons and the pre-synaptic neurons ready to fire;
determining potential values of the post-synaptic neurons upon fire; and
updating next firing times and values for the pre-synaptic neurons and the post-synaptic neurons.

20. A non-transitory computer-readable medium having stored thereon instructions for operating an event-based neural network, the instructions executable by a processing unit for:
(i) setting an initial state of the network;
(ii) determining a next event in the network as a time to a next neuron firing by:
(a) populating entries of a top level of at least one multi-level comparator with values representative of neuron firing times;
(b) comparing pairs of entries and selecting from each pair an entry having a closest neuron firing time;
(c) propagating the selected ones from each pair to a next level of the comparator and updating the entries of the top level with one or more new values;
(d) repeating steps (b) and (c) until all top level entries are updated and no new values are written to any level of the comparator; and
(e) determining the time to a next neuron firing based on the neuron firing time of the value in the final level;
(iii) setting a subsequent time of simulation to the next neuron firing time;
(iv) simulating the network at the subsequent time of simulation; and
(v) repeating steps (ii) to (iv) iteratively during operation of the network.
